(19) United States
(12) Patent Application Publication
(10) Pub. No.: US 2022/0085666 A1
(43) Pub. Date: Mar. 17, 2022

(54) OUTDOOR LOCATION SYSTEM OF INDOOR WIRELESS GATEWAY

(71) Applicant: ARRIS Enterprises LLC, Suwanee, GA (US)

(72) Inventor: John Charles CHAMBERLAIN, Hickory, NC (US)

(21) Appl. No.: 17/408,683

(22) Filed: Aug. 23, 2021

Related U.S. Application Data
(60) Provisional application No. 63/079,204, filed on Sep. 16, 2020.

(51) Int. Cl. H02J 50/80; H04W 88/08; H04B 5/00

(52) U.S. Cl. CPC H02J 50/80; H04B 5/0031; H04B 5/0037; H04W 88/08

(57) ABSTRACT

The external network connection device includes a housing, a location indicator disposed on the housing, an external connector configured to connect to the communication channel, a data receiver configured to wirelessly receive a data signal through an external wall, a power receiver configured to wirelessly receive a power signal through the external wall and to power the external network connection device via the received power signal, an electromagnetic signal detector configured to detect the data signal or the power signal at an external side of the external wall and to generate a directional indication signal based on location of the detected at least one of the data signal and the power signal. The location indicator is configured to indicate a location of the electromagnetic signal at the external side of the external wall.

### BACKGROUND

Embodiments of the present disclosure relate to a millimeter wave transmissions, and more particularly, to a manner for improving installation of systems for building penetration for millimeter wave transmissions.

### SUMMARY

Aspects of the present disclosure are drawn to an external network connection device for use with a dwelling, an indoor network communication device, a service provider server, and a communication channel, the dwelling having an external wall, the indoor network communication device being affixed to an internal side of the external wall and being configured to wirelessly emit a data signal through the external wall and to wirelessly emit a power signal through the external wall, the service provider server being configured to provide a service flow via the communication channel. The external network connection device includes a housing, a location indicator disposed on the housing, a data receiver configured to wirelessly receive the data signal through the external wall, a power receiver configured to wirelessly receive the power signal through the external wall and to power the external network connection device via the received power signal, an electromagnetic signal detector configured to detect at least one of the data signal and the power signal at an external side of the external wall and to generate a directional indication signal based on location of the detected at least one of the data signal and the power signal, and a fastening mechanism configured to fasten the housing to the external side of the external wall, wherein the location indicator is configured to indicate a location of the electromagnetic signal at the external side of the external wall.

In some embodiments, the electromagnetic signal detector is further configured to generate a second directional indication signal based on the detected at least one of the data signal and the power signal over the external side of the external wall when the housing is moved from a first position on the external side of the external wall to a second position on the external side of the external wall.

Other aspects of the present disclosure are drawn to a method of using an external network connection device with a dwelling, an indoor network communication device, a service provider server, and a communication channel, the dwelling having an external wall, the indoor network communication device being affixed to an internal side of the external wall and being configured to wirelessly emit a data signal through the external wall and to wirelessly emit a power signal through the external wall, the service provider server being configured to provide a service flow via the communication channel. The method includes wirelessly receiving, via a data receiver, the data signal through the external wall, wirelessly receiving, via a power receiver, the power signal through the external wall, powering, via the power receiving, the external network connection device via the received power signal, detecting, via an electromagnetic signal detector, at least one of the data signal and the power signal at an external side of the external wall, generating, via the electromagnetic signal detector, a directional indication signal based on location of the detected at least one of the data signal and the power signal, indicating, via a location indicator, a location of the electromagnetic signal at the external side of the external wall, fastening, via a fastening mechanism, a housing that houses the data receiver, the power receiver and the electromagnetic signal detector, to the external side of the external wall, and connecting the external network connection device to the communication channel so as to receive the service flow from the service provider server.

In some embodiments, the method of using the detection device is further configured to generate, via the electromagnetic signal detector, a second directional indication signal based on the detected at least one of the data signal and the power signal over the external side of the external wall when the housing is moved from a first position on the external side of the external wall to a second position on the external side of the external wall.

Other aspects of the present disclosure are drawn to a non-transitory, computer-readable media having computer-readable instructions stored thereon, the computer-readable instructions being capable of being read by a detection device for use with a dwelling, an indoor network communication device, a service provider server, and a communication channel, the dwelling having an external wall, the indoor network communication device being affixed to an internal side of the external wall and being configured to wirelessly emit a data signal through the external wall and to wirelessly emit a power signal through the external wall, the service provider server being configured to provide a service flow via the communication channel. The computer-readable instructions are capable of instructing the external network connection device to perform the method including wirelessly receiving, via a data receiver, the data signal through the external wall, wirelessly receiving, via a power receiver, the power signal through the external wall, powering, via the power receiving, the external network connection device via the received power signal, detecting, via an electromagnetic signal detector, at least one of the data signal and the power signal at an external side of the external wall, generating, via the electromagnetic signal detector, a directional indication signal based on location of the detected at least one of the data signal and the power signal, indicating, via a location indicator, a location of the electromagnetic signal at the external side of the external wall, fastening, via a fastening mechanism, a housing that houses the data receiver, the power receiver and the electromagnetic signal detector, to the external side of the external wall, and connecting the external network connection device to the communication channel so as to receive the service flow from the service provider server.

In some embodiments, the non-transitory, computer-readable media having computer-readable instructions stored thereon is further configured wherein the computer-readable instructions are capable of instructing the external network connection device to perform the method further including generating, via the electromagnetic signal detector, a second directional indication signal based on the detected at least one of the data signal and the power signal over the external side of the external wall when the housing is moved from a first position on the external side of the external wall to a second position on the external side of the external wall.

Other aspects of the present disclosure are drawn to an indoor network communication device for use with a dwelling, an external network connection device, a service provider server, and a communication channel, the dwelling having an external wall, the service provider server being configured to provide a service flow via the communication channel, the external network connection device being configured to be affixed to an external side of the external wall and to connect to the communication channel so as to receive the service flow from the service provider server. The indoor network communication device includes a housing configured to be affixed to an internal side of the external wall, a power connector configured to conduct power to the indoor network communication device, a data signal emitter configured to wirelessly emit a data signal through the external wall, a power emitter configured to wirelessly emit a power signal through the external wall, and a transmitter configured to transmit an installation signal to the service provider server upon receiving power from the power source.

### BRIEF SUMMARY OF THE DRAWINGS

The accompanying drawings, which are incorporated in and form a part of the specification, illustrate example embodiments and, together with the description, serve to explain the principles of the present disclosure. In the drawings:

FIG. 1A illustrates a portion of a dwelling, at a time t₀;

FIG. 1B illustrates the dwelling of FIG. 1A, at a time t₁;

FIG. 1C illustrates the dwelling of FIG. 1A, at a time t₂;

FIG. 2A illustrates a portion of another dwelling, at a time t₃;

FIG. 2B illustrates the dwelling of FIG. 2A, at a time t₄;

FIG. 2C illustrates the dwelling of FIG. 2A, at a time t₅;

FIG. 3 illustrates a method for positioning an external network connection device on the external side of the external wall;

FIG. 4A illustrates a portion of a dwelling, at a time t₆, in accordance with aspects of the present disclosure;

FIG. 4B illustrates the dwelling of FIG. 4A, at a time t₇;

FIG. 4C illustrates the dwelling of FIG. 4A, at a time t₈;

FIG. 5 illustrates an exploded view of the external wall;

FIG. 6 further illustrates the exploded view of the external wall of FIG. 5;

FIG. 7A further illustrates the exploded view of the external wall of FIG. 6;

FIG. 7B further illustrates the exploded view of the external wall of FIG. 7A;

FIG. 8 further illustrates the exploded view of the external wall of FIG. 5;

FIG. 9 illustrates an exploded view of the network devices of FIG. 4A;

FIG. 10A illustrates a portion of another dwelling, at a time t₉, in accordance with further aspects of the present disclosure;

FIG. 10B illustrates the dwelling of FIG. 10A, at a time t₁₀; and

FIG. 10C illustrates the dwelling of FIG. 10A, at a time t₁₁.

### DETAILED DESCRIPTION

The current state of the art of installing a network to a residence or enterprise includes installation both outside and inside the residence/enterprise. There are logistic, technical, cost, aesthetic, and home privacy issues associated with the current state of the art for attaching the network from the outdoors to the indoor customer premises equipment (CPE) network and eventually the customer.

Residence or enterprise network installation requires technician visits, or “truck rolls.” Although a network provider tries for one installation visit, typically at least two or more visits from the network provider are required. One for outdoor customer enablement that depending on the type of network may involve burying cable, mounting an antenna, and placing electronics or a Network Interface Device (closures) on the outside of the residence. Then a second truck roll is typically required for the technician to physically drill a hole from the outside of the residence to the inside to run some type of cable connectivity. This is typically twisted pair, Ethernet, coax, or optical fiber. During this second visit the customer CPE is also set up by the network provider or subcontractor. This step can sometimes require multiple truck rolls to coordinate the visit with the new customer. Another logistics issue is that the network operator does not always locate the indoor to outdoor connection point at a location that the consumer would like, appreciate, or is even possible to access from the inside of the home.

Power must be provided to the electronics. Based on the network connectivity technology (wireless antenna/radio, PON, etc.), power can be required at the outside unit. In this case, power either needs to be supplied by the network or the customer. Both have challenges. In the case of network powering connectivity, this needs to be supplied by the network provider. This has both capital expenditures and operational expenditures associated with them, which the operator would prefer not to incur. Home powering, on the other hand, can have negative effects on customer relationships due to the customer perception of their dollar powering the network. Other technical considerations include having fiber cable indoors which can be broken, or directional mounting of an antenna in the case of wireless service providers.

As mentioned above, the operator would like to limit the number of technician trucks rolls to a minimum, ideally zero or one. Depending on many variables including organized vs. non-organized labor, a truck roll can cost between $150 and $600 per roll. The network provider would like to defer powering costs to the consumer and this is easier to do if all the electronics are on the inside of the home, as consumers are used to “plugging in” electrical appliances to operate them.

Where the network operator indoor/outdoor connection point is or “needs” to be and where the consumer would like it to be are not typically the same.

Consumers would prefer to not have technicians that they do not know in their home. With the advent of the COVID-19 pandemic, this takes on additional concern. Newly available technology exists that allows a wireless connection between the indoor and outdoor devices/networks. Both data/information and power can be transmitted wirelessly to eliminate the need to drill a hole from the inside to the outside of a residence. This requires two units, one indoor and one outdoor, and they should be aligned through a wall or window to operate. The technology can be used with any type of network connectivity, e.g., DSL, DOCSIS, PON, or Wireless. State of the art allows for up to 60 watts of power to be transmitted up to 30 cm.

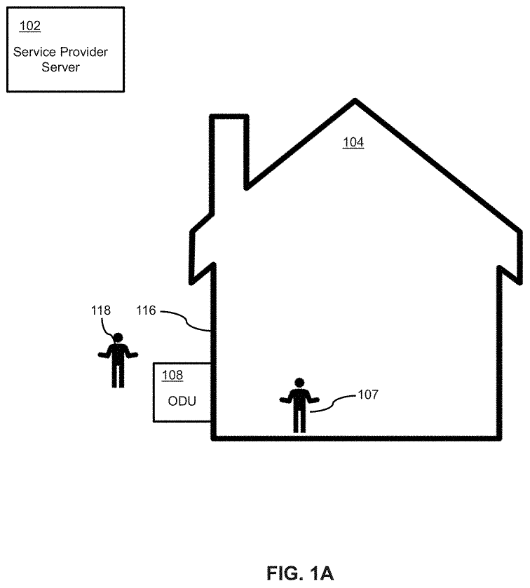

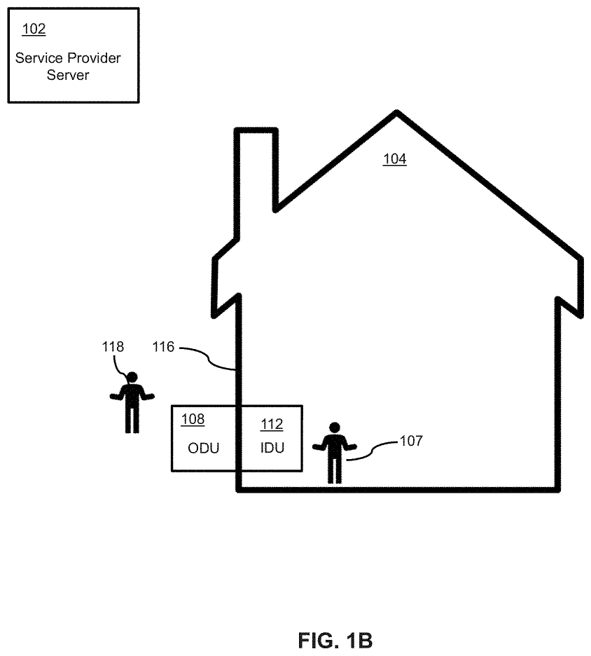

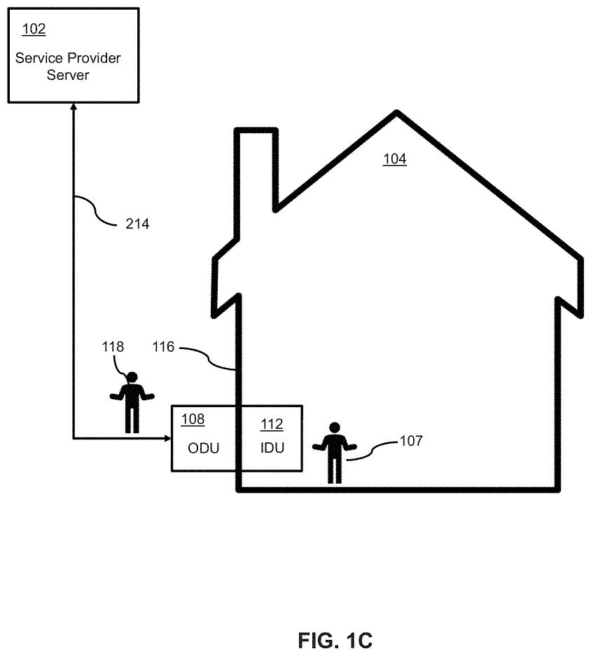

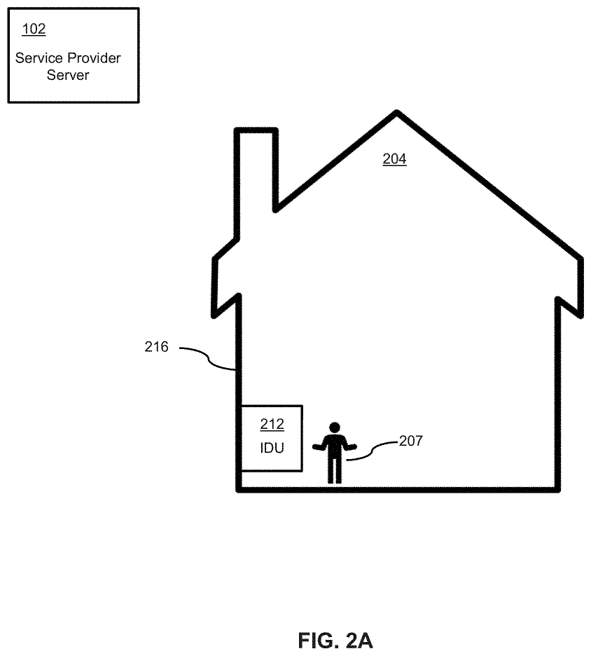

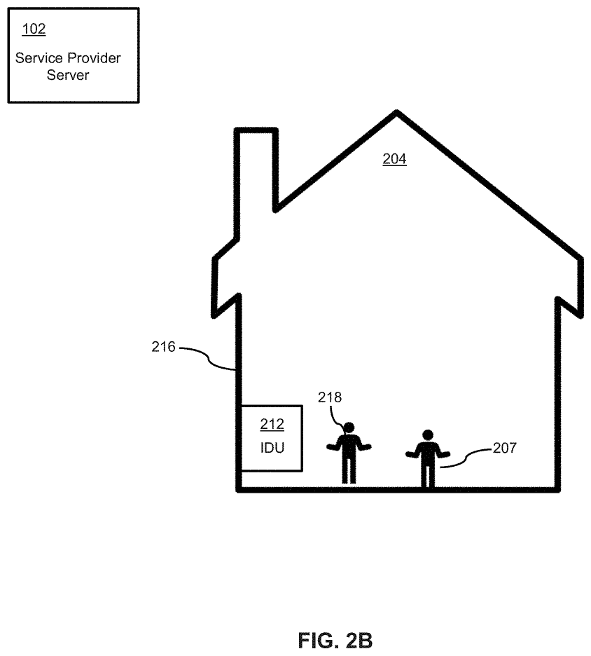

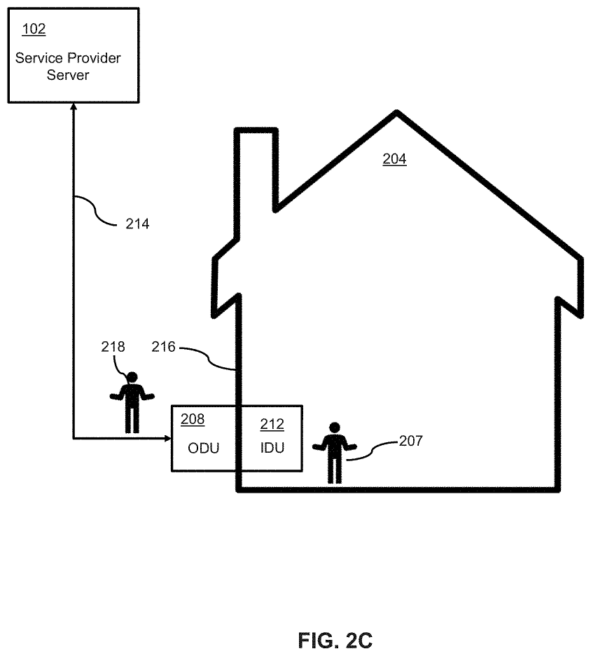

This technology solves many of the connectivity issues outlined above, including 1) indoor to outdoor powering/cost of network powering, 2) no drilling of holes in walls, and 3) ideally only one truck roll required to enable the customer location from the network to the home, including burying cable, mounting/positioning an outdoor antenna, etc. The idea with respect to 3) above is to send a network technician to accomplish the outdoor work and then ship the indoor device with directions on how to power and align with the outdoor device. The issues of aesthetics and ease of installation on the consumer have remained. The project has met with disappointing acceptance to date. Many of the technical issues are resolved but because the outdoor installation technician puts the outdoor unit where they think it should be, the indoor unit may be ill placed aesthetically, at an interior wall, not close to a power outlet, or a number of other issues. This will be described in greater detail with reference to FIGS. 1A-2C.

In one example conventional installation process, an outdoor unit is first installed by a technician. Then an indoor unit will be installed by a customer. This will be described in greater detail with reference to FIGS. 1A-C.

FIG. 1A illustrates a portion of a dwelling 104, at a time to. As shown in the figure, dwelling 104 includes a user 107, and an external wall 116. Outside of dwelling 104 are a service provider server 102, an external network connection device 108, and a technician 118.

Technician 118 acts to position external network connection device 108 at a location on the exterior of external wall 116. Technician 118 positions external network connection device 108 in accordance with device operating guidelines, and perceived convenience of user 107. Technician 118 then typically physically drills a hole from the outside of the residence to the inside to run some type of cable connectivity, such as twisted pair, Ethernet, coax, or optical fiber.

FIG. 1B further illustrates the portion of dwelling 104 of FIG. 1A, at a time t₁, with the addition of an indoor network communication device 112.

User 107 acts to position indoor network communication device 112 on the interior of external wall 116, in accordance with instructions from technician 118 or the service provider. These instructions are based upon where technician 118 has positioned external network connection device 108.

FIG. 1C further illustrates the portion of dwelling 104 of FIG. 1A, at a time t₂, with the addition of a communications channel 214 outside of dwelling 104.

External network connection device 108 is arranged to communicate with service provider server 102 by way of communication channel 214. Communication channel 214 is configured to establish one of DSL, DOSCIS, FTTH (PON), or wireless connectivity with service provider server 102.

In another example conventional installation process, the indoor unit is first installed. Then the outdoor unit will be installed by the technician, wherein the technician must entry the residence to find the location of the indoor unit. This will be described in greater detail with reference to FIGS. 2A-C.

FIG. 2A illustrates a portion of a dwelling 204, at a time t₃. As shown in the figure, dwelling 204 includes a user 207, an indoor network communication device 212, and an external wall 216. Outside of dwelling 204 is service provider server 102.

User 207 acts to position indoor network communication device 212 at a location on the interior of external wall 216, in accordance with instructions from a technician or the service provider. These instructions are based upon system operating requirements. User 207 then informs the service provider that indoor network communication device 212 has been positioned. Service provider sends technician 218 to dwelling 204 as referenced in FIG. 2B.

FIG. 2B further illustrates the portion of dwelling 204 of FIG. 2A, at a time t₄, with the addition of technician 218.

Technician 218 enters dwelling 204 and observes the location of indoor network communication device 212. Technician 218 then typically physically drills a hole from the inside of the residence to the outside to run some type of cable connectivity, such as twisted pair, Ethernet, coax, or optical fiber.

FIG. 2C further illustrates the portion of dwelling 204 of FIG. 2A, at a time t₅, with the addition of an external network connection device 208, a communication channel 214, and technician 218 outside of dwelling 204.

Technician 218 acts to position external network connection device 208 on the exterior of the external wall 216 opposite his estimated location of indoor network communication device 212. External network connection device 208 is arranged to communicate with service provider server 102 by way of communication channel 214.

What is needed is a system and method for positioning an external network connection device on the external side of the external wall that overcomes the logistic, technical, cost, aesthetic, and home privacy issues discussed above.

A system and method in accordance with the present disclosure for positioning an external network connection device on the external side of the external wall overcomes the logistic, technical, cost, aesthetic, and home privacy issues discussed above.

Aspect in accordance with the present disclosure include: 1) a change in installation process, 2) remote notification of installation, and 3) associated technologies and devices that facilitate the proposed change in installation process.

An installation process in accordance with aspects of the present disclosure includes providing the indoor unit of the wireless technology component, at the same time as the CPE, and let the customer install in the inside of their home with simple instructions. For example, if the installation is for land line service (e.g., DSL, PON, and DOCSIS), then the inside box should be mounted on an outside wall within 6 feet of ground level. If for wireless service with directional component, download application to locate direction of closest tower or access point (AP). The AP shows which side of the house is acceptable, and the device should be mounted on that side of house. In either case, when mounted, connect to power. Again, this allows the customer to place the device in a location aesthetically pleasing and close to a power outlet such that he doesn't mind where the power cord is. In this way the customer decides where he wants the device on the inside of his home, enabling acceptance of the technology.

Another aspect of the present disclosure is drawn to remote notification of installation. This may be accomplished in a number of ways. A non-limiting example includes a phone call or text to a number in the directions sent for home installation. Another non-limiting example includes a message with GPS, serial number of the device, or other identifying information sent via wireless to a cell tower.

Another aspect of the present disclosure is drawn to facilitation of outdoor installation. Since the outside device is powered from inside the dwelling, the wireless power signal can be located in a gross sense with a wand, mobile phone AP, or other device. Once the general location is found, the outside unit will be aligned with the inside unit by placing outside and having location indicator lights on the outside device that allow the technician to align the outside device with the inside device. Once aligned, the service can be provisioned and checked. Regardless of whether land line or wireless, this should reduce truck rolls to one per installation, and potentially zero for wireless installation, if the outdoor unit can be shipped at the same time as the indoor unit, the customer installs the outdoor unit in the correct side of the home and there is an antenna array in the outdoor unit capable of self-alignment with the closest wireless AP.

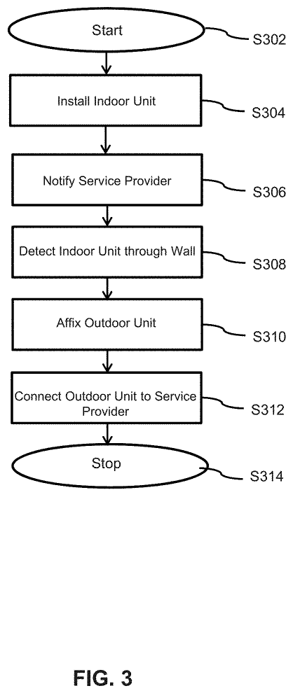

Aspects of the present disclosure are drawn to a system and method for providing an external network connection device configured to detect at least one of a data signal and a power signal at the external side of an external wall from an indoor network communication device, to generate a directional indication signal based on location of the detected at least one of the data signal and the power signal, and a fastening mechanism configured to fasten the housing to the external side of the external wall, wherein the location indicator is configured to indicate a location of the electromagnetic signal at the external side of the external wall, in accordance with aspects of the present disclosure will now be described in greater detail with reference to FIGS. 3-10C.

FIG. 3 illustrates a method 300 of using an external network connection device, in accordance with aspects of the present disclosure.

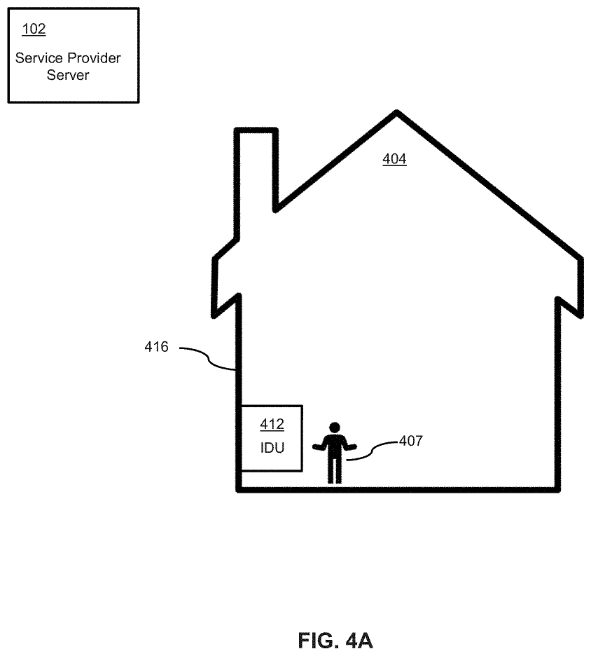

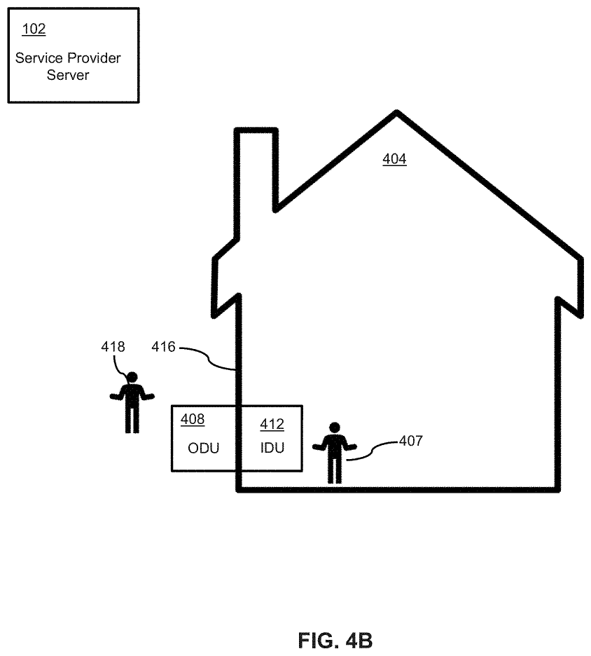

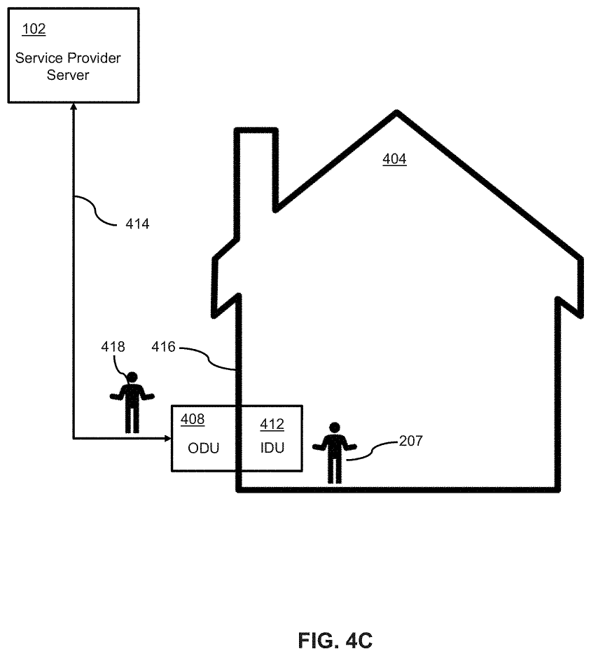

As shown in the figure, method 300 starts (S302), and an indoor unit is installed (S304). For example, a user may position the indoor network communication device on an interior surface, at a position that they desire, of an external wall of a residence. This will be described in greater detail with reference to FIG. 4A.

FIG. 4A illustrates a portion of a dwelling 404, at a time t₆, in accordance with aspects of the present disclosure. As shown in the figure, dwelling 404 includes a user 407, an indoor network communication device 412, and an external wall 416. Outside of dwelling 404 is service provider server 102.

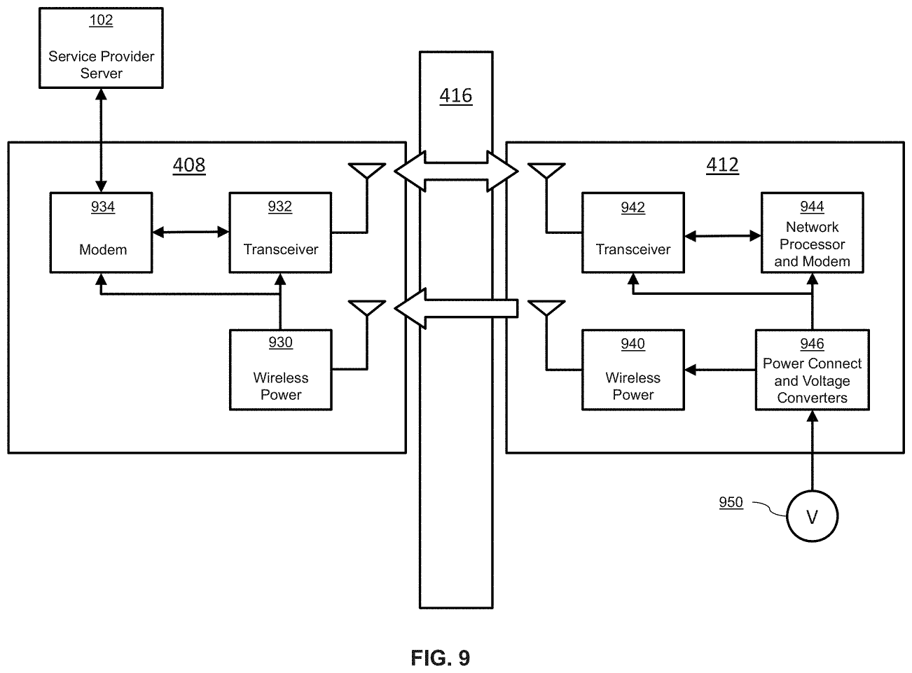

User 407 acts to position indoor network communication device 412 at a location on the interior of external wall 416 in accordance with device operating guidelines. However, user 407 may choose a location anywhere within those guidelines that is aesthetically pleasing and is convenient to user 407. User 407 acts to provide electrical power to indoor network communication device 412. In one embodiment, user 407 connects indoor network communication device 412 to dwelling 404 AC power by way of plugging into a wall outlet. In another embodiment, user 407 acts to insert batteries into indoor network communication device 412. In a further embodiment, user 407 connects indoor network communication device 412 to a power adaptor transformer by way of a USB, miniUSB, or microUSB port, or the like. A more detailed discussion of external network communication device 408 and indoor network communication device will now be provided with additional reference to FIG. 9.

FIG. 9 illustrates an exploded view of indoor network communication device 412 and external network connection device 408, in accordance with aspects of the present disclosure.

As shown in FIG. 9, indoor network communication device 412 includes a wireless power emitter 940, a data wireless transceiver 942, a network processor and broadband modem 944, and a power connector and voltage converters 946. Indoor network communication device 412 receives power from a power supply 950. Power supply 950 could provide either AC or DC power to power connector and voltage converters 946, which receives the power and converts it to levels usable throughout indoor network communication device 412. Power connector and voltage converters 946 can include an AC power cord, a battery receptacle, a USB, miniUSB, or microUSB port, and the like.

Returning to FIG. 9, external network connection device 408 includes a wireless power receiver 930, a wireless data transceiver 932, and a broadband modem 934. External network connection device 408 communicates with service provider server 102. Indoor network communication device 412 is arranged to provide power to external network connection device 408 by way of a wireless power signal, as shown in the figure by the single-headed arrow. Indoor network communication device 412 is arranged to communicate with external network connection device 408 by way of a wireless data communication signal, as shown in the figure by the double-headed arrow.

In this example, wireless power emitter 940, data wireless transceiver 942, network processor and broadband modem 944, and power connector and voltage converters 946 are illustrated as individual devices of indoor network communication device 412. However, in some embodiments, at least two of wireless power emitter 940, data wireless transceiver 942, network processor and broadband modem 944, and power connector and voltage converters 946 may be combined as a unitary device. Further, in some embodiments, at least one of wireless power emitter 940, data wireless transceiver 942, network processor and broadband modem 944, and power connector and voltage converters 946 may be implemented as a computer having non-transitory computer-readable media for carrying or having computer-executable instructions or data structures stored thereon.

In this example, wireless power receiver 930, wireless data transceiver 932, and broadband modem 934 are illustrated as individual devices of external network connection device 408. However, in some embodiments, at least two of wireless power receiver 930, wireless data transceiver 932, and broadband modem 934 may be combined as a unitary device. Further, in some embodiments, at least one of wireless power receiver 930, wireless data transceiver 932, and broadband modem 934 may be implemented as a computer having non-transitory computer-readable media for carrying or having computer-executable instructions or data structures stored thereon.

Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from, and write information to the tangible computer-readable media. In the alternative, the tangible computer-readable media may be integral to the processor. The processor and the tangible computer-readable media may reside in an integrated circuit (IC), an application specific integrated circuit (ASIC), or large scale integrated circuit (LSI), system LSI, super LSI, or ultra LSI components that perform a part or all of the functions described herein. In the alternative, the processor and the tangible computer-readable media may reside as discrete components.

Example tangible computer-readable media may be also be coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Components of an example computer system/server may include, but are not limited to, one or more processors or processing units, a system memory, and a bus that couples various system components including the system memory to the processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

A program/utility, having a set (at least one) of program modules, may be stored in the memory by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of various embodiments of the application as described herein.

Network processor and broadband modem 944 can include hardware circuitry such as a dedicated control circuit, a CPU, a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of internal network communication device 412 and external network connection device 408 in accordance with the embodiments described in the present disclosure.

Returning to FIG. 3, after an indoor unit has been installed (S304), the service provider is notified (S306). For example, indoor network communication device 412 may send a message to the service provider that user 407 has installed indoor network communication device 412.

In one embodiment, once power is established to indoor network communication device 412, there is a wireless connectivity device within indoor network communication device 412 that connects to the service provider to send a one-time or multiple times message that informs the service provider that indoor network communication device 412 is powered on. This informs the service provider that user 407 has positioned indoor network communication device 412 and the network is ready to provision external network connection device 408. Indoor network communication device 412 can connect wirelessly to the service provider using wireless communication technologies, such as LTE, 4G, 5G, or the like. The service provider then sends technician 418 to dwelling 404 to provision external network connection device 408, as referenced in FIG. 4B.

As shown in FIG. 9, network processor and broadband modem 944 can further include a memory that can store various programming, and user content, and data. In one embodiment, network processor and broadband modem 944 can further include one or more connectors, such as RF connectors, or Ethernet connectors, and/or wireless communication circuitry, such as 5G circuitry and one or more antennas. In one further embodiment, network processor and broadband modem 944 can further include a Wi-Fi WLAN interface radio transceiver operable to communicate with client devices and mobile devices. In such an embodiment, network processor and broadband modem 944 includes one or more antennas and communicates wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. In a yet further embodiment, network processor and broadband modem 944 can further include a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands, or the 60 GHz bands, RF4CE protocol, ZigBee protocol, Z-Wave protocol, or IEEE 802.15.4 protocol.

Returning to FIG. 3, after the service provider has been notified (S306), the indoor unit is detected through the wall (S308). For example, technician 418 uses external network connection device 408 to determine the position of indoor network communication device 412 as referenced in FIG. 4B.

FIG. 4B further illustrates a portion of dwelling 404 of FIG. 4A, at a time t₇, with the addition of external network connection device 408 and technician 418 outside of dwelling 404.

Indoor network communication device 412 is arranged to wirelessly power external network connection device 408. Indoor network communication device 412 is arranged to wirelessly communicate with external network connection device 408.

Technician 418 acts to position external network connection device 408 on the exterior of the external wall, opposite the location of indoor network communication device 412. Technician 418 begins by wirelessly determining the approximate location of the indoor network communication device 412, as disclosed in greater detail below.

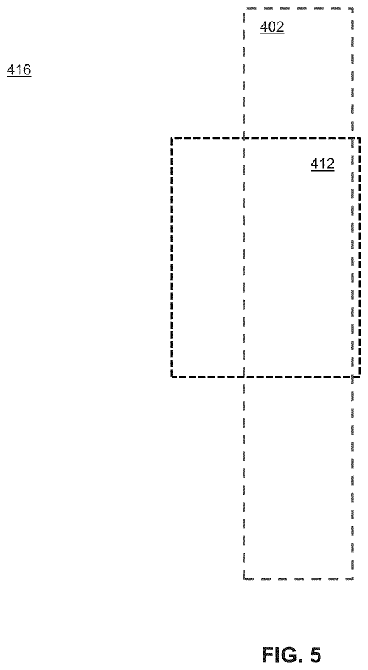

FIG. 5 illustrates an exploded view of external wall 416, looking through it from the exterior side. As shown in the figure, external wall 416 includes an obstruction 402. The location of indoor network communication device 412 is shown with a dashed outline.

Obstruction 402 is any non-homogeneity within the wall. Examples of non-homogeneous materials include studs of wood or steel, concrete pillars, electrical wiring, plumbing piping, and the like. The presence of obstruction 402 will affect to some degree the power distribution of a wireless communication or power signal, as further disclosed below.

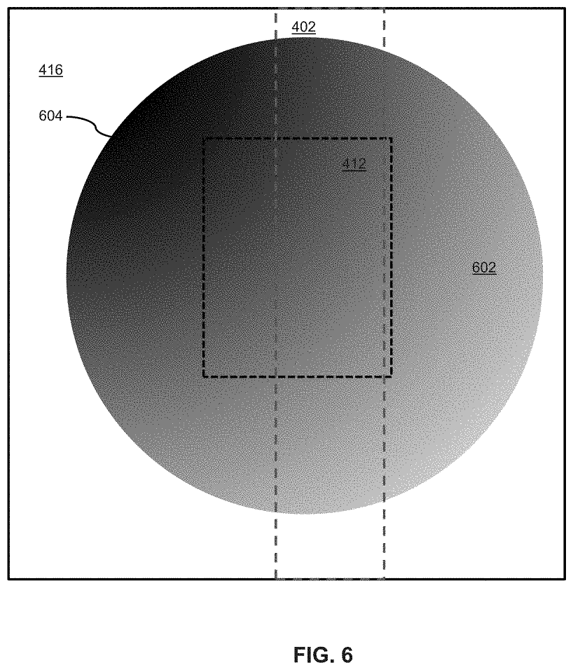

FIG. 6 illustrates the exploded view of external wall 416 shown in FIG. 5, with the addition of propagation pattern 602 of signal power. The location of the highest intensity of the propagated pattern is shown at 604.

In this example, indoor network communication device 412 is arranged to power external network connection device 408 by way of transmitting a wireless power signal. Indoor network communication device 412 is also arranged to communicate with external network connection device 408 by way of transmitting a wireless communication signal. Transmission of either of these signals establishes propagation pattern 602.

External wall 416 may contain obstruction 402 within propagation pattern 602 from indoor network communication device 412. Obstruction 402 may cause location of the highest intensity of the propagated pattern to be offset from indoor network communication device 412. The present disclosure overcomes that offset by provisioning external network connection device 408 at the optimal location that maximizes received power of the signal from indoor network communication device 412.

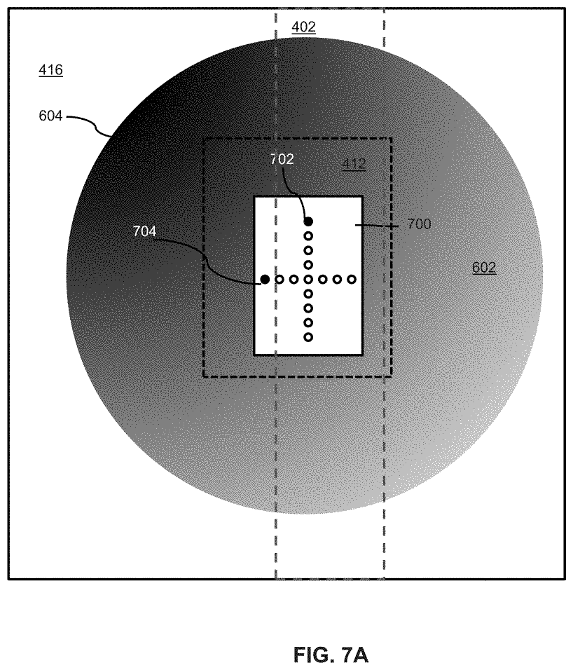

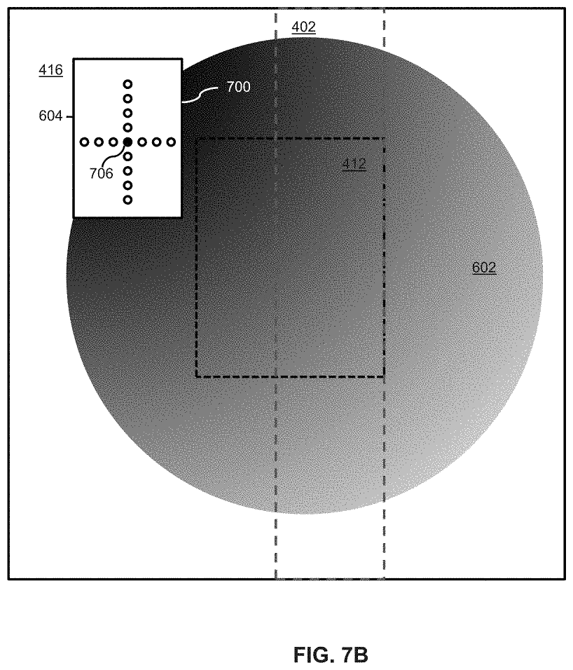

FIG. 7A illustrates the exploded view of external wall 416 shown in FIG. 6, with the addition of indicator display 700. By way of non-limiting example, the display includes a vertical row of LEDs and a horizontal row of LEDs. Differing assemblages of LEDs varying by size, color, arrangement, or the like, are envisioned by the inventors as further embodiments. Yet further embodiments would use other visual or aural display technologies that serve to indicate direction and distance to the location of maximum received signal power.

Indicator display 700 is arranged to display detection of the propagation pattern 602. By way of non-limiting example, the figure shows indicator display 700 indicating the location of the highest pattern intensity 604 by turning on the appropriate LEDs in the vertical and horizontal rows. In this example, the uppermost LED 702 of the vertical row and the leftmost LED 704 of the horizontal row are on, indicating the location of the highest pattern intensity 604 is up and to the left of the current position of indicator display 700.

Technician 418 uses indicator display 700 to find the approximate location of indoor network communication device 412. Once technician 418 finds the approximate location, indicator display 700 indicates the movements required to maximize the power of the received signal from indoor network communication device 412. The received power is maximized when the indoor network communication device 412 is positioned to receive the signal at the location of the highest pattern intensity 604.

FIG. 7B further illustrates the exploded view of external wall 416 of FIG. 7A, with the addition of movement of indicator display 700. The centermost LED 706 is on.

By way of non-limiting example, the figure shows indicator display 700 indicating that indicator display 700 is positioned at the location of the highest pattern intensity 604 by turning on the LED at the center of the vertical and horizontal rows. In this example, the centermost LED 706 of the vertical row and the horizontal row is ON, indicating the indicator display 700 is currently positioned at the optimal location of the highest pattern intensity 604.

Returning to FIG. 3, after the indoor unit has been detected through the wall (S308), the outdoor unit is affixed (S310). For example, technician 418 fastens external network connection device 408 to the exterior of the external wall 416.

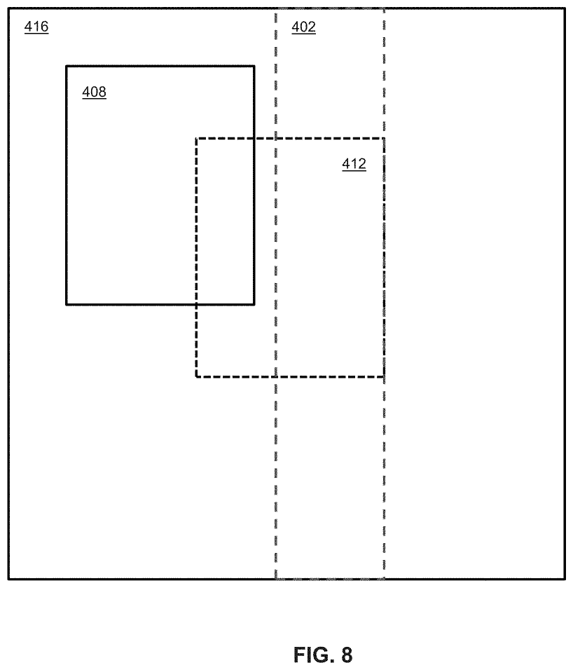

FIG. 8 illustrates the exploded view of external wall 416 shown in FIG. 5, with the addition of external network connection device 408.

External network connection device 408 is arranged to be positioned at the location of the highest pattern intensity 604. Technician 418 then fastens external network connection device 408 to the exterior of the external wall 416 at that location.

Returning to FIG. 3, after the outdoor unit has been affixed (S310), the outdoor unit is connected to the service provider (S312). For example, external network connection device 408 is arranged to communicate with service provider server 102 by way of communication channel 414 as referenced in FIG. 4C.

FIG. 4C further illustrates a portion of dwelling 404 of FIG. 4A, at a time t₈, with the addition of communication channel 414 outside of dwelling 404.

External network connection device 408 is arranged to communicate with service provider server 102 by way of communication channel 414.

Returning to FIG. 9, broadband modem 934 connects to service provider server 102 by way of communication channel 414, by way of an external connector either through physical media/wiring, such as a coaxial network, an optical fiber network, and/or DSL, wherein the external connector may be implemented as a port that able to receive and transmit data to the physical media/wiring or through wireless network, such as a satellite or terrestrial antenna implemented network, wherein the external connector may be implemented as radio frequency transceiver device or a combination of any of these examples or their equivalents. The data communication in such network can be implemented using a variety of protocols on a network such as a wide area network (WAN), a virtual private network (VPN), metropolitan area networks (MANs), system area networks (SANs), a DOCSIS network, a fiber optics network (e.g., FTTH (fiber to the home), FTTX (fiber to the X), or hybrid fiber-coaxial (HFC)), a digital subscriber line (DSL), a public switched data network (PSDN), a global Telex network, or 3G, 4G, or 5G, for example.

Returning to FIG. 3, after the outdoor unit has been connected to the service provider (S312), method 300 stops (S314).

Technician 418 has now provisioned external network connection device 408 at the optimal location for wireless data communication with indoor network communication device 412. Technician 418 has acted to accomplish this result with only one visit to dwelling 404, performed at the service provider's convenience with no interaction with user 407 needed to accomplish this task.

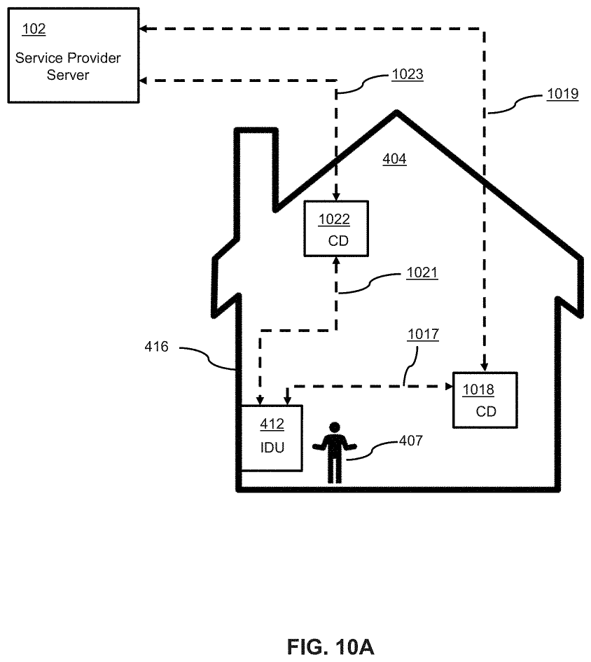

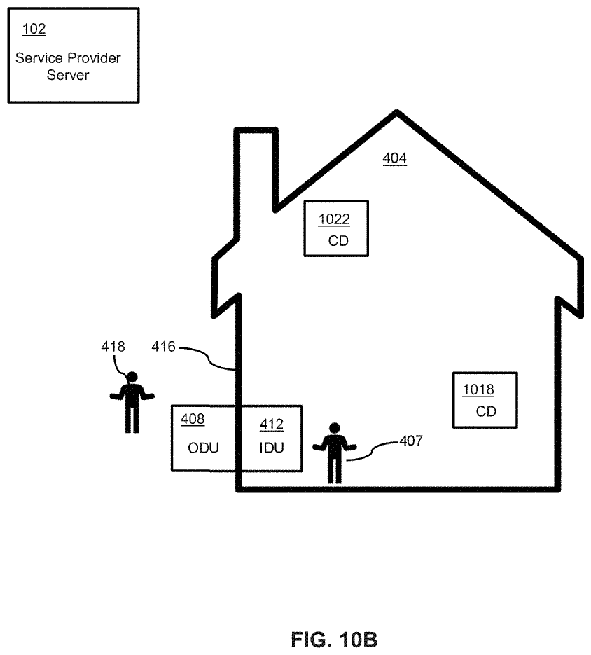

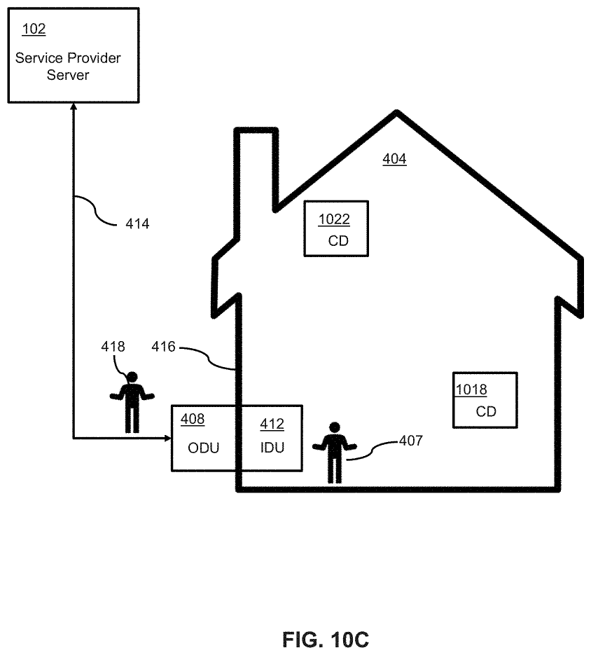

FIG. 10A illustrates in a further embodiment a portion of dwelling 404, at a time t₉, in accordance with aspects of the present disclosure. As shown in the figure, dwelling 404 includes user 407, indoor network communication device 412, external wall 416, client device (CD) 1018, and CD 1022. Dwelling 404 also includes communication channels 1017, 1019, 1021, and 1023. Outside of dwelling 404 is service provider server 102.

User 407 acts to position indoor network communication device 412 at a location on the interior of external wall 416. In this further embodiment, and by way of non-limiting example, upon being positioned, indoor network communication device 412 is arranged to communicate its status to service provider server 102 by way of one of either communication channel 1017 and communication channel 1019, or communication channel 1021 and communication channel 1023. In one further example, indoor network communication device 412 is arranged to communicate with CD 1018 by way of communication channel 1017, and CD 1018 is arranged to communicate with service provider server 102 by way of communication channel 1019. In yet another further example, indoor network communication device 412 is arranged to communicate with CD 1022 by way of communication channel 1021, and CD 1022 is arranged to communicate with service provider server 102 by way of communications channel 1023.

Once power is established to indoor network communication device 412, there is a wireless connectivity device within indoor network communication device 412 that connects to the service provider to send a one-time or multiple times message that informs the service provider that indoor network communication device 412 is powered on. This informs the service provider that user 407 has installed indoor network communication device 412 and the network is ready to provision external network connection device 408. Indoor network communication device 412 can connect wirelessly to the service provider using wireless communication technologies, such as LTE, 4G, 5G, or the like. The service provider then sends technician 418 to dwelling 404 to provision external network connection device 408.

In a further embodiment, indoor network communication device 412 connects to the service provider by way of CD 1018, where CD 1018 can be another service provider device such as a cable TV converter box, which then communicates with the service provider server using the established cable TV communication path. In a yet further embodiment, indoor network communication device 412 connects to the service provider by way of CD 1022, where CD 1022 can be another service provider device such as a satellite network converter box, which then communicates with the service provider server using the established satellite network communication path.

FIG. 10B further illustrates a portion of dwelling 404 of FIG. 10A, at a time t₁₀, with the addition of external network connection device 408 and technician 418 outside of dwelling 404.

Indoor network communication device 412 is arranged to wirelessly power external network connection device 408. Indoor network communication device 412 is arranged to wirelessly communicate with external network connection device 408.

Technician 418 acts to position external network connection device 408 on the exterior of the external wall, opposite the location of indoor network communication device 412. Technician 418 begins by wirelessly determining the approximate location of the indoor network communication device 412, as disclosed above.

FIG. 10C further illustrates a portion of dwelling 404 of FIG. 10A, at a time t₁₁, with the addition of communication channel 414 outside of dwelling 404.

External network connection device 408 is arranged to communicate with service provider server 102 by way of communication channel 414.

Broadband modem 934 connects to service provider server 102 by way of communication channel 414, either through physical media/wiring 122, such as a coaxial network, an optical fiber network, and/or DSL, or through wireless network 124, such as a satellite or terrestrial antenna implemented network or a combination of any of these examples or their equivalents. The data communicated on such network can be implemented using a variety of protocols on a network such as a wide area network (WAN), a virtual private network (VPN), metropolitan area networks (MANs), system area networks (SANs), a DOCSIS network, a fiber optics network (e.g., FTTH (fiber to the home), FTTX (fiber to the X), or hybrid fiber-coaxial (HFC)), a digital subscriber line (DSL), a public switched data network (PSDN), a global Telex network, or 3G, 4G, 5G, or 6G for example.

Technician 418 has now provisioned external network connection device 408 at the optimal location for wireless data communication with indoor network communication device 412. Technician 418 has acted to accomplish this result with only one visit to dwelling 404, performed at the service provider's convenience with no interaction with user 407 needed to accomplish this task.

The foregoing description of various preferred embodiments have been presented for purposes of illustration and description. It is not intended to be exhaustive or to limit the present disclosure to the precise forms disclosed, and obviously many modifications and variations are possible in light of the above teaching. The example embodiments, as described above, were chosen and described in order to best explain the principles of the present disclosure and its practical application to thereby enable others skilled in the art to best utilize the present disclosure in various embodiments and with various modifications as are suited to the particular use contemplated. It is intended that the scope of the present disclosure be defined by the claims appended hereto.

What is claimed is:

1. A external network connection device for use with a dwelling, an indoor network communication device, a service provider server, and a communication channel, the dwelling having an external wall, the indoor network communication device being affixed to an internal side of the external wall and being configured to wirelessly emit a data signal through the external wall and to wirelessly emit a power signal through the external wall, the service provider server being configured to provide a service flow via the communication channel, said external network connection device comprising:
a housing;
a location indicator disposed on said housing;
a data receiver configured to wirelessly receive the data signal through the external wall;
a power receiver configured to wirelessly receive the power signal through the external wall and to power said external network connection device via the received power signal;
an electromagnetic signal detector configured to detect at least one of the data signal and the power signal at an external side of the external wall and to generate a directional indication signal based on location of the detected at least one of the data signal and the power signal; and
a fastening mechanism configured to fasten the housing to the external side of the external wall,
wherein the location indicator is configured to indicate a location of the electromagnetic signal at the external side of the external wall.

2. The external network connection device of claim 1, wherein said electromagnetic signal detector is further configured to generate a second directional indication signal based on the detected at least one of the data signal and the power signal over the external side of the external wall when said housing is moved from a first position on the external side of the external wall to a second position on the external side of the external wall.

3. A method of using an external network connection device with a dwelling, an indoor network communication device, a service provider server, and a communication channel, the dwelling having an external wall, the indoor network communication device being affixed to an internal side of the external wall and being configured to wirelessly emit a data signal through the external wall and to wirelessly emit a power signal through the external wall, the service provider server being configured to provide a service flow via the communication channel, said method comprising:
wirelessly receiving, via a data receiver, the data signal through the external wall;
wirelessly receiving, via a power receiver, the power signal through the external wall;
powering, via the power receiving, the external network connection device via the received power signal;
detecting, via an electromagnetic signal detector, at least one of the data signal and the power signal at an external side of the external wall;
generating, via the electromagnetic signal detector, a directional indication signal based on location of the detected at least one of the data signal and the power signal;
indicating, via a location indicator, a location of the electromagnetic signal at the external side of the external wall;
fastening, via a fastening mechanism, a housing that houses the data receiver, the power receiver and the electromagnetic signal detector, to the external side of the external wall; and
connecting the external network connection device to the communication channel so as to receive the service flow from the service provider server.

4. The method of claim 3, wherein said method further comprises generating, via the electromagnetic signal detector, a second directional indication signal based on the detected at least one of the data signal and the power signal over the external side of the external wall when the housing is moved from a first position on the external side of the external wall to a second position on the external side of the external wall.

5. A non-transitory, computer-readable media having computer-readable instructions stored thereon, the computer-readable instructions being capable of being read by an external network connection device for use with a dwelling, an indoor network communication device, a service provider server, and a communication channel, the dwelling having an external wall, the indoor network communication device being affixed to an internal side of the external wall and being configured to wirelessly emit a data signal through the external wall and to wirelessly emit a power signal through the external wall, the service provider server being configured to provide a service flow via the communication channel, wherein the computer-readable instructions are capable of instructing the external network connection device to perform the method comprising:
wirelessly receiving, via a data receiver, the data signal through the external wall;
wirelessly receiving, via a power receiver, the power signal through the external wall;
powering, via the power receiving, the external network connection device via the received power signal;
detecting, via an electromagnetic signal detector, at least one of the data signal and the power signal at an external side of the external wall;
generating, via the electromagnetic signal detector, a directional indication signal based on location of the detected at least one of the data signal and the power signal;
indicating, via a location indicator, a location of the electromagnetic signal at the external side of the external wall;
fastening, via a fastening mechanism, a housing that houses the data receiver, the power receiver and the electromagnetic signal detector, to the external side of the external wall; and
connecting the external network connection device to the communication channel so as to receive the service flow from the service provider server.

6. The non-transitory, computer-readable media of claim 5, wherein the computer-readable instructions are capable of instructing the external network connection device to perform the method further comprising generating, via the electromagnetic signal detector, a second directional indication signal based on the detected at least one of the data signal and the power signal over the external side of the external wall when the housing is moved from a first position on the external side of the external wall to a second position on the external side of the external wall.

7. An indoor network communication device for use with a dwelling, an external network connection device, a service provider server, and a communication channel, the dwelling having an external wall, the service provider server being configured to provide a service flow via the communication channel, the external network connection device being configured to be affixed to an external side of the external wall and to connect to the communication channel so as to receive the service flow from the service provider server, said indoor network communication device comprising:
a housing configured to be affixed to an internal side of the external wall;
a power connector configured to conduct power to the indoor network communication device;
a data signal emitter configured to wirelessly emit a data signal through the external wall;
a power emitter configured to wirelessly emit a power signal through the external wall; and
a transmitter configured to transmit an installation signal to the service provider server upon receiving power from the power source.
